(19) United States
(12) Patent Application Publication
(10) Pub. No.: US 2007/0235523 A1
(43) Pub. Date: Oct. 11, 2007

(54) System and method for cash deposit/issuance

(75) Inventor: James F. Clements, Englewood Cliffs, NJ (US)

Correspondence Address: Alfred W. Froebrich, Esq.;Cohen Pontani Lieberman & Pavane LLP, Suite 1210, 551 Fifth Avenue, New York, NY, 10176, US

(73) Assignee: Compuflex Corporation

(21) Appl. No.: 11/784,311

(22) Filed: Apr. 5, 2007

Related U.S. Application Data
(60) Provisional application No. 60/789,338, filed on Apr. 5, 2006.

(51) Int. Cl. G07F 19/00; G06F 7/08

(52) U.S. Cl. 235/379; 235/381

(57) ABSTRACT

A method, a framework, a computer program product and a system for conducting cash deposit/issuance transactions in which the actual cash deposit/issuance occurs at a cash issuing/accepting system, i.e., cash handling station that is separate from the transaction processing point. This approach addresses both the issuance of cash to customers and the receipt of cash from customers. The approach is generic in the sense that any Microsoft Windows based application or Microsoft Windows based Terminal Emulator may act as the source of information relating to cash to be issued to a customer/user or serve as the target for the automatic entry of information relating to cash accepted at a remote or central point by a customer/user. The approach employs a remote cash management software module with OCR and Keyboard emulation components which co-resides with the transaction processing application in one or more Microsoft Windows based computers which are networked to one or more cash issuing/accepting systems running separate cash issuance/acceptance software modules.

### CROSS REFERENCE TO RELATED APPLICATIONS

This application claims priority from U.S. Provisional Patent Application Ser. No. 60/789,338 which was filed on Apr. 5, 2006.

### BACKGROUND OF THE INVENTION

1. Field of the Invention

The present invention relates to a method, system and computer program(s) for conducting transaction(s) involving cash issuance or cash deposits in which the actual cash deposit/issuance occurs at a cash handling station that is separate from the transaction processing point.

2. Description of the Related Art

For some financial transactions, it is advantageous to automate the cash handling process, i.e., cash dispensation/deposit. For example, in a recycling application, a user deposits items to be recycled, i.e., cans or scrap metal, and is issued a receipt indicative of an amount due. The user is then required to remit the receipt to a cashier to collect the money. The operator of the recycling facility must constantly man a cashier station for that purpose.

In another recycling scenario, a recycling station is installed in a supermarket or other store in which cashiers are already present to process customer purchases. In this case, the recyclers may not be actual customers of the store and thus place an additional burden on the cashiers. This adds to the time it takes to process the actual customers of the store. Accordingly, the store hosting the recycling station would benefit by automated cash dispensation for the recyclers.

Furthermore, in some banking situations, it is desirable for the cash handling portion of a transaction to be performed separately from the teller. In such cases, the teller does not have a large amount of cash and there is less incentive to rob or steal from the tellers.

### SUMMARY OF THE INVENTION

An object of the present invention is to provide a method, system and computer program for conducting or facilitating a transaction involving cash issuance or cash deposit in which the actual cash deposit/issuance occurs at a cash handling station that is separate from the transaction processing point.

If a cash deposit is part of the transaction, a customer first deposits the cash at the cash handling station and the information related to the deposit is saved with a unique identifier or ‘Tag’ to a ‘received cash’ file in a network server. After depositing the cash in the secure cash handling station, the customer is issued a receipt. The customer then performs the transaction at a transaction processing point, the cash deposit being part of the transaction. For example, if the system is installed at a bank and the customer wishes to deposits checks and cash to an account, the customer first deposits the cash at the cash handling station and receives a receipt. The customer then presents the checks and cash deposit receipt at the transaction processing point to perform/complete the entire transaction. Alternatively, the customer can deposit both the cash and the checks at the cash handling station.

For a transaction involving a cash issuance, the customer first processes the transaction at the transaction processing point which saves this information with a unique identifier or ‘Tag’ in a ‘pending issuance’ file in the network server. The customer is issued the unique identifier or tag associated with the transaction located in the ‘pending issuance’ file. To redeem the cash, the customer enters the unique identifier at the cash handling station which interrogates the network server to determine the amount of cash to be issued.

In both the cash issuance and cash deposit embodiments described above, the unique identifier may be a unique number generated at the cash handling station or the transaction processing point. Furthermore, the unique number may be printed as a bar code on the receipt issued to the customer. In an alternative embodiment, the unique identifier or ‘tag’ may be included in an RFID device issued to the customer. In the cash deposit embodiment, the customer would receive the RFID device at the cash handling station and present the RFID device to the transaction processing point to call up the information from the ‘received cash’ file. In the cash issuance embodiment, the RFID is issued at the transaction processing point and presented to the cash handling station which reads the RFID device, calls up the associated ‘pending issuance’ file from the network, and issues the associated amount of cash.

In yet another alternative, the ‘tag’ or identifier may comprise information on a magnetic card or smart card owned by a customer such as, for example, a credit card with a magnetic strip. For cash deposit, the customer slides a credit card (or any other magnetic card or smart card owned by the user) through a card reader at the cash handling station. The cash handling station obtains the information, i.e., the ‘tag’, from the card and associates the ‘tag’ with the transaction. The customer then presents the credit card at the transaction processing point to call up the saved information from the ‘received cash’ file to complete the transaction. For cash issuance, the ‘tag’ is obtained from the credit card at the transaction processing point and the credit card is presented at the cash handling station to call up the transaction information from the ‘pending issuance’ file and issue the cash.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a flow diagram showing the steps for effecting a cash issuance procedure according to an embodiment of the present invention;

FIG. 2 is a flow diagram showing the steps for effecting a cash issuance procedure according to a further embodiment of the present invention;

FIG. 3 is a flow diagram showing the steps for effecting a cash deposit procedure according to an embodiment of the present invention;

FIG. 4 is a schematic block diagram of various elements of a software package according to an embodiment of the present invention; and

FIG. 5 is a schematic diagram of a system in which the procedures of the flow diagrams of FIGS. 1-3 are performed according to an embodiment of the present invention.

### DETAILED DESCRIPTION OF THE PRESENTLY PREFERRED EMBODIMENTS

### The Cash Issuance/Acceptance System

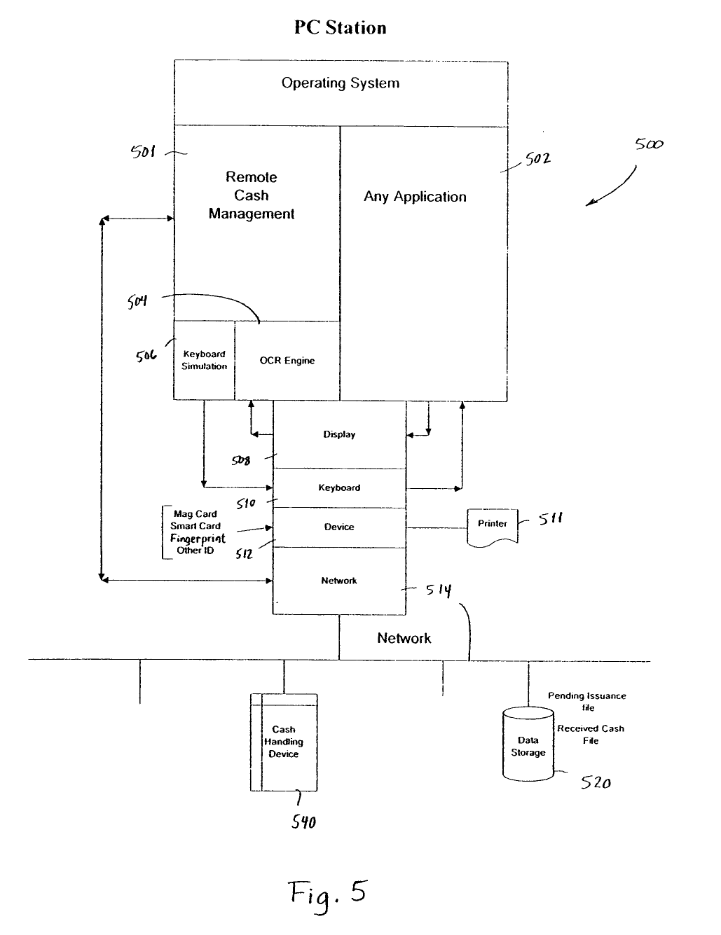

FIG. 5 is a schematic diagram of a network which includes PC Stations such as those manned by tellers 500, data storage mechanisms such as a server 520 and cash handling stations 540 for issuing and accepting cash. The PC stations 500, cash handling station(s) 540 and server(s) 520 are connected via a network 514 such as, for example, a wired or wireless local area network. Also indicated in FIG. 5 are the components of the cash issuance/acceptance system including a first module comprising a Remote Cash Management (RCM) software 501, a second module comprising a further application 502 described in more detail below, an OCR engine 504 used to extract cash and other related transactional information from a screen, a keyboard simulation module 506 responsible for automatically passing cash acceptance and/or other transactional information to any target application. Although the RCM software 501 is only shown in the PC station 500, components of the RCM software may also be present in the cash handling stations 540 as described below. A data storage area in the server 520 is used to queue pending cash issuance requests received from the PC station based RCM software 501 and/or pending cash deposit information placed there by the cash handling station 540 for processing at the PC station 500. The further application 502 may comprise prior art teller or other customer processing applications to which the RCM software 501 and the customer interface hardware described below is either already present or added. The operating system of the PC Station is preferably Windows based, but can be any operating system known or hereafter developed. The RCM software 501 includes the keyboard simulation module 506 and the OCR engine 504. The first and second modules may comprises program modules which are both run by the operating system of the PC station. Alternatively, the first and second modules may also be associated with separate hardware components.

Each of the PC Stations 500 includes a display 508 and an input device such as a keyboard 510. Each PC station 500 further includes ‘tagging’ mechanism 512 which may issue a bar code or a numeric value to a printer 511. Alternatively, the tagging mechanism 512 may accept ‘tagging’ information, such as magnetic card stripe information, for uniquely identifying cash issuance transaction information or identifying cash acceptance information associated with cash to be presented at cash handling stations 540 (described in more detail below). Note that ‘tagging’, for purposes of the system described herein, is the process whereby some form of unique information is either generated by the RCM software 501 or input, upon direction of the RCM software 501. If the unique information is generated, it may be printed as a human readable value and/or an encoded image such as a bar code. Printer 511 must be available at the PC station for the tagging approach in which the tag is generated. If the unique information is to be input, the RCM software 501 will prompt the customer for the swiping of a magnetic card, the insertion of a smart card, the touching of a fingerprint reading device, the indication to bring an RFID device in proximity to a reader, or the operation of any other biometric or other mechanism which may be used to obtain a one time use ‘tag’ for the current transaction.

Each cash handling station 540 includes a means for dispensing cash and change. The dispensing means may include dispensing devices that are arranged in ATM machines and change dispensing devices such as those arranged in ticket dispensing machines which are known. The cash handling station may also comprise cash acceptance devices such as those disposed on vending machines, bulk note deposit (i.e. bills are presented to and are processed by such a mechanism as a packet or stack) or cash recycling (i.e. bills may be accepted by the mechanism in a manner similar to the bulk note mechanism however the received notes may be separated and stored by denomination and used to satisfy cash issuance requests) ATMs. Although only one PC station 500 and one cash handling station 540 are shown, the system may include plural PC stations 500 and plural cash handling stations 540. Furthermore, each cash handling station 540 may be specifically designed for either accepting cash, dispensing cash, or both accepting and dispensing cash. A data storage device such as a server 520 connected to the network 514 stores pending transactions relating to cash to be issued at the cash handling station 540 or cash which has been received by the cash handling station 540.

### Cash Issuance

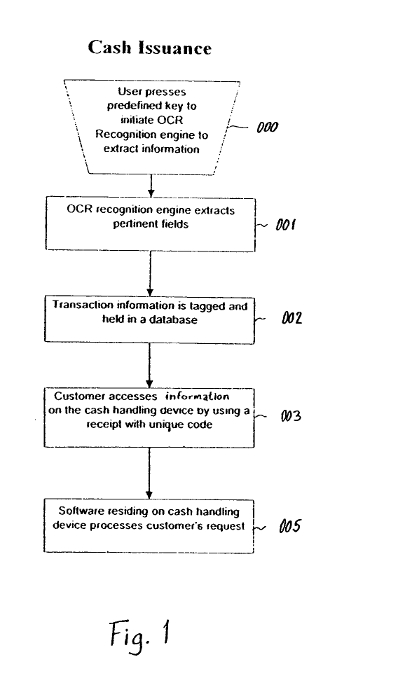

FIG. 1 is a flow diagram showing the steps for effecting a cash issuance procedure. The approach assumes the presence of a PC system running Microsoft Windows and any application such as a teller software application 502. Co-residing with the application 502 is the RCM software 501 which includes an optical character recognition (OCR) engine 504 and the keyboard simulation module 506. When the RCM software 501 is installed, a process, supported by this software, is used to identify all of the application's 502 screens and fields of interest (e.g. names of screens containing cash issuance information, specific locations within each of these screens from which the OCR engine 504 can identify and extract the issuance amount and other information specific to that transaction). The process also supports the identification of fields into which information such as cash deposit amounts/counts or other pertinent data may be loaded by the keyboard simulation module 506. The RCM software 501 is activated through the use of a unique key stroke or key combination (i.e. ‘Hot Key’) via the keyboard 510 at step 000 of FIG. 1. The unique key stroke may be input at the keyboard input device 510. This unique key stroke causes the software OCR engine 504 to first confirm that the currently displayed screen is one which has been predefined at installation and is thus valid for the data extraction process.

Step 001 assumes that the application 502 is displaying the amount to be issued to the customer and any other related information. The OCR engine 504 upon activation by the operator extracts the issuance amount and other information which might be useful for audit purposes such as, for example, the number of the account from which a withdrawal is made and passes this to the RCM software 501. Alternatively, the transaction information may be presented to the application by an operator or customer via an input device, such as a document scanner. As a further alternative, the RCM software 501 may obtain the issuance amount and other information directly from the application 502. In any case, the extracted transactional information is passed to the application 502 (if not already present there) and at least a portion of the transactional information relating to the customer cash issuance amount is passed to the RCM software 501.

Once the information extracted by the OCR engine 504 is entered into the PC station 500, the RCM software 501 will then either create or prompt for information that will be used to uniquely ‘Tag’/identify the data for this, step 002. As stated above, the tag may be a unique numeric code or bar code generated by the RCM software 501 and output to a printer 511. In this case, a receipt, including this printer ‘tag’ information is given to the customer who will be directed to a cash handling station 540 for the transactional cash to be issued. Instead of generating a tag by issuing a numeric code or bar code, the RCM software 501 may prompt the customer to swipe a magnetic card or insert a smart card at the tag device 512 and use the retrieved information as the tag. As a further alternative, the range of tagging devices may include various biometric readers/scanners for obtaining biometric information from the customer (such as, for example, fingerprint, iris information, or facial profile) for use as the tag. In the latter case, the RCM software 501 could prompt the user to ‘Please place your right index finger on the scanner’. Regardless of how the information is obtained, the information or data forms a unique tag which is associated with the transaction information. The tag and transaction information is then added to a ‘Pending Issuance’ file located on a data server 520 connected to the network 514.

To redeem the cash, the user moves to the cash handling station 540 and enters the tag (i.e., the unique code), step 004. If the code is a bar code, the cash handling station is assumed to include a bar code reader. If a numerical code is used, the user will be required to enter the code at the cash handling station 540 using a numeric keypad, touch screen or keyboard. After the code is entered, the cash handling station software checks the ‘Pending Issuance’ file located on the data server 520 for the presence of the tag (in this case the unique code) and its related data. If the tag is present, the cash handling station 540 will issue the transaction amount to the user, step 005. The transaction will be marked as being processed and the details for this cash issuance task will be added to an audit journal.

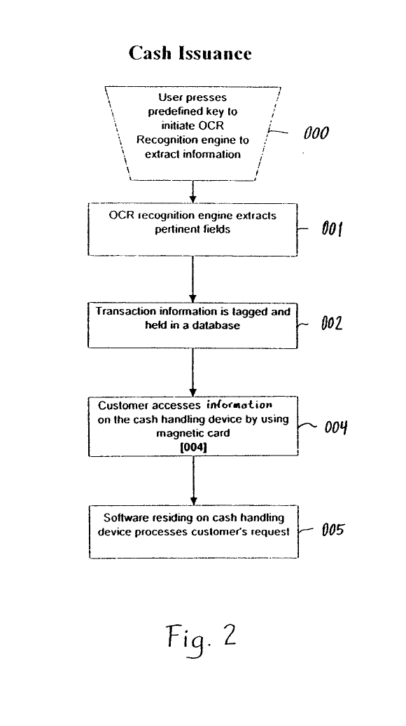

In an alternative embodiment shown in FIG. 2, the tag includes information retrieved from a magnetic card or a smart card, step 002. In this embodiment, the user will be prompted to present the card, step 004, at the cash handling station 540. Any magnetic card or smart card may be used for this purpose such as, for example, a user's credit card or bank card, since the card number/information is only used internally to identify a specific transaction.

The transaction cash will be issued once the card information is entered at the cash handling station, step 005. In this case, the card is immediately returned once the transaction is confirmed and the cash issued. If the customer is reluctant to use his/her own card or the customer is un-banked or does not have a magnetic card, a magnetic card owned by the institution such as a bank branch may be used to tag the transaction at the PC station 500 at step 002 and then given to the customer who is then directed to the cash handling station 540. In this case, once the card number/information is verified and the cash issued, the magnetic or smart card is retained by the cash handling station for reuse.

Instead of magnetic or smart cards, the transaction may also be tagged using RFID cards, fingerprint scans, iris scans, facial profile or other biometric scans or any other known or hereafter developed method or means for associating a unique identifier with the transaction so that only the holder of the information can redeem the cash.

The above description relates to use of a PC station 500 supporting an application such as a teller software package 502. The transactional amount and related information is obtained from the screen using the OCR engine 504. However, application 502 running on the PC station could be any type of system which includes the issuance of cash to the customer/user. Other examples of market areas where the RCM system might be used include recycling companies which receive bulk metals, bulk paper, rags, cans, bottles, etc. from customers in return for cash and coin deposit machines in which customers insert coins which are counted and the customer then receives a coupon which can redeemed for larger bills. Once the materials or coins are received and weighed and/or counted, the total cash amount to be issued to the customer would be displayed or printed by the application software 502 which is specific to the industry. The process described above for identifying and accessing the transactional information, executing the tagging process and allowing the customer to access and be issued the transactional cash is performed identically in these other market areas. Check cashing companies and Pay day advance companies would also benefit from the use of the RCM system as an adjunct to the customer processing software that they are using.

### Cash Deposit

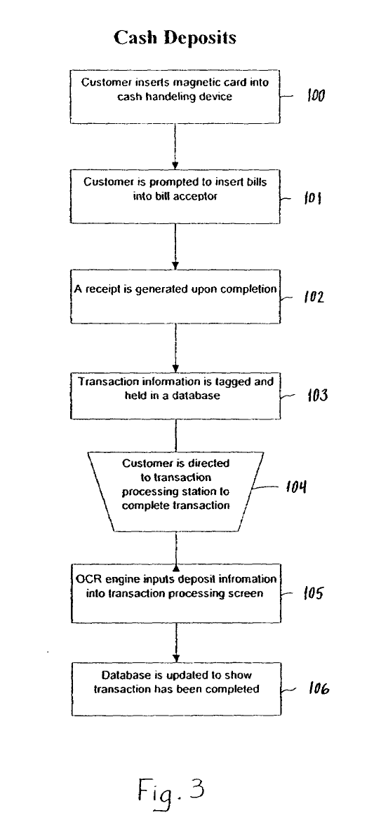

FIG. 3 is a flow diagram showing the steps for effecting a cash deposit. At step 100 a tag is created at a cash handling station 540 for the transaction. The tag can be created in many ways as described above, however, a magnetic or smart card either assigned to the institution representative such as a bank teller or a magnetic card supplied by the customer is preferably used. The cash deposit transaction is initiated at the cash handling machine 540 and is ultimately completed at a PC station 500 using Microsoft Windows based operating system, the application software 502 responsible for processing the complete customer transaction, and the co-resident RCM software 501 with its associated OCR engine 504 and keyboard simulation module 506 for passing data into the transaction processing application software 502.

At the cash handling station 540, the information from the magnetic or smart card is entered by the customer or institution representative presenting the card to a card reader, step 100. Once the information from the presented card is obtained, a tag is created which will be used to identify the cash received data once the cash has been accepted and stored. The customer is prompted to present the cash, step 101, to the cash acceptance component of the cash handling station 540. The cash acceptance component may, for example, include a single bill acceptor which accepts one bill at a time, bulk note acceptor which accepts a stack of bills, or cash recycler which also receives cash in a stack or ‘bunch’. However, any other cash acceptance component known or hereafter developed may also be used. As described above, the controlling software for this cash handling station 540 includes components of the RCM software approach as described above.

Once the cash has been accepted, the cash handling station 540 issues a receipt indicating the composition of cash accepted, date, time, location number and other information as might be necessary, step 102. The cash handling station 540 provides for manual entry or correction of the amount to address situation when a portion of the cash is not or cannot be accepted by the cash acceptance component. The correction could be made by a supervisory staff having authority to make such changes. An indication of the supervisory staff identification may be included on the receipt.

The transaction information with the tag (i.e., information from the magnetic or smart card) is added to a ‘Received Cash’ file located on the data server 520. The magnetic or smart card is then returned to the customer or institution representative—after step 103 but before step 104. The customer/institution representative is directed to complete the transaction at one of the PC stations 500. At the PC station 500, the application 502 responsible for processing the complete transaction is invoked and the customer identification information (e.g. account number) is entered, typically by the teller (in the case of a bank branch).

When the screen relating to the entry of cash received is reached, a ‘hot key’ would be pressed to activate the RCM software 501, which prompts for the tag (e.g. provided by swiping the magnetic card or inserting the smart card) associated with the cash deposit process handled at the remote cash station 540, step 104. According to the present embodiment, the tag includes information on a card. Thus, step 104 would prompt the user to swipe the card in a card reader. The card number (tag information) is then used to access the information associated with the cash which was accepted at the cash handling station 540 and stored in the ‘Received Cash’ file located on the data server 520.

The tag information input at the transaction processing station is compared with the receipt by the operator and upon acceptance, the cash data is automatically entered into the appropriate data entry screen associated with the application 502 by the keyboard simulation module 506, step 105. The keyboard simulation module 506 simulates the keyboard entry of the information by an institution representative such as a teller at the PC station 500.

The related record in the ‘Received Cash’ file is marked as being processed and the audit file is updated accordingly, step 106.

Although the example of FIG. 3 uses a magnetic card reader to produce the tag for the transaction, any of the procedures for generating a tag described above may be used. For example, the cash handling device 540 may generate a numerical code or bar code that is associated with the transaction. Alternatively, the cash handling device may uses a biometric scan such as a fingerprint scan, iris scan, facial profile, or any other known or hereafter developed method or means for associating a unique identifier with the transaction so that only the holder of the information may access issued cash or control the movement of cash deposit information into a transaction processing application 502.

### ATM Transaction Processing

The above described cash issuance and acceptance systems are based on ATM technology. Accordingly, the cash handling stations 540 may optionally be configured to also handle ATM transactions in the event that a magnetic card is presented which is not tied to an internal issuance/acceptance operation. In this embodiment, a proper ATM card is presented to the cash handling station 540. If an internal ‘pending issuance’ transaction located on the data server 520 is associated with the ATM card, then it will be handled and the card returned to the customer. If there is no member of the ‘Pending Issuance’ file with a matching tag in the data server, the card information will be passed to the software component responsible for ATM transaction processing. The card number/information will be passed to the ATM processing subsystem and the customer will be prompted to enter a PIN. Normal ATM processing will follow. Thus, there is no chance that a proffered card would not be properly handled. When the transaction has completed, the system will again be prepared to handle a local issuance/acceptance transaction or an ATM transaction.

### Software Breakdown

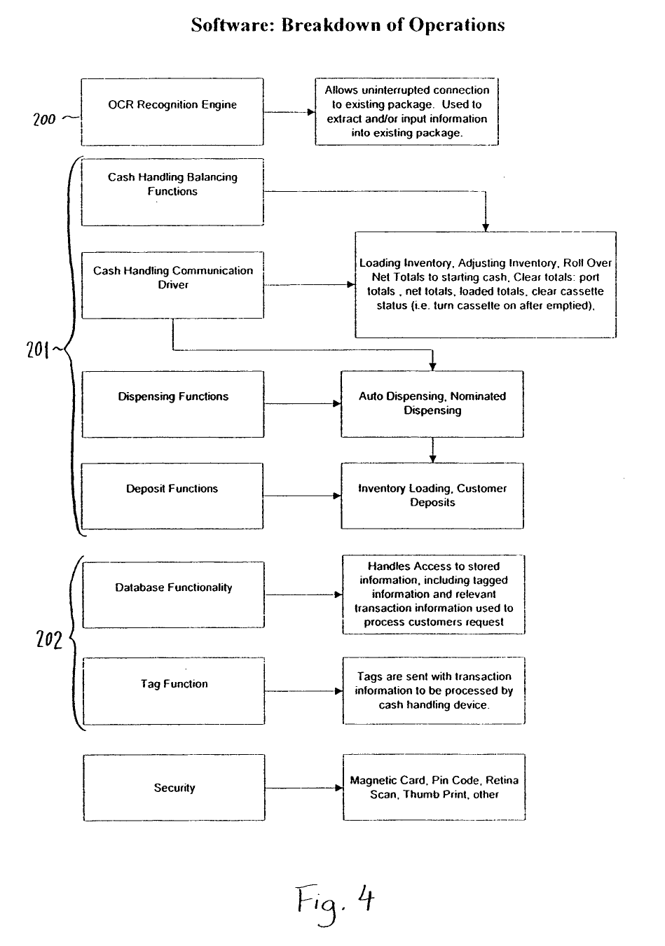

FIG. 4 is a schematic block diagram of the various elements of the RCM software 501 including the OCR recognition engine, the keyboard simulation ‘engine’, the cash handler driver, and the tagging/database functions.

The OCR engine 200 handles the functions of extraction and insertion of information from existing teller or other applications. The information such as amount to be issued to the customer and other related information which may be needed for audit purposes can be extracted from applications 502 such as a teller package. This information may be used to effect cash issuance at the cash handling station 540. Likewise, if a customer has deposited funds at the cash handling station 540, this tagged information can be accessed at the PC station 500 and can be inserted into denomination fields, to complete the transaction.

The cash handler driver 201 provides the ability to dispense, deposit, and balance the cash device. This driver provides a ‘link’ between the cash handling station and the RCM software 501 resident on PC station 500. The driver accesses the cash handling station's cash management hardware component(s) (e.g. dispensers, single or bulk note acceptors, cash recyclers, coin dispensers, coin acceptance units, coin recyclers) through serial, USB, network or other connectivity modalities.

The tag information functional block 202 is used to process a transaction. Information can be tagged either as a bar code, or number that can be placed on a receipt. This information is stored on a database and retrieved by the cash handling station. For deposits, the reverse process will take place, in which the cash handling station will tag information that is later processed at the teller station.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for cash handling applicable to an industry, comprising:
a database storing transaction related information for at least one transaction;
a terminal having a first module configured to generate transactions related to the industry and a second module configured to receive or obtain transaction related information related to the transaction generated by said first module, assign a tag or indicator to the transaction related information, and save the transaction related information in association with the assigned tag or indicator in said database, wherein the transaction related information includes a cash amount; and
a cash handling device remote from said terminal and connected to said database by a network, said cash handling device comprising an input device configured to receive an input tag or indicator, said cash handling machine further configured to look up the input tag or indicator in said database and determine the transaction related information associated with the input tag or indicator, and dispense the cash amount of the transaction related information associated with the input tag or indicator.

2. The system of claim 1, wherein said second module directly receives the transaction related information from said first module.

3. The system of claim 1, wherein said terminal includes a display screen and said second module obtains the transaction data through extraction from the display screen.

4. The system of claim 1, wherein the industry is banking.

5. The system of claim 1, wherein the industry is waste recycling.

6. The system of claim 1, wherein the industry is check cashing.

7. The system of claim 1, wherein said tag or indicator is a number.

8. The system of claim 7, wherein said tag or indicator is a bar coded representation of the number, and said cash handling device comprises a bar code reader configured to read the input tag or indicator.

9. The system of claim 1, wherein said tag or indicator includes information on a magnetic card, said cash handling device having a card reader for reading the input tag or indicator.

10. The system of claim 1, wherein said tag or indicator includes information on an RFID component, said cash handling device having an RFID reader device for reading the input tag or indicator.

11. The system of claim 1, wherein said tag or indicator includes biometric information, each of said terminal and said cash handling machine including a biometric device.

12. The system of claim 1, wherein said terminal is a coin deposit machine configured to receive coins, wherein said transaction related information indicates an amount of currency received.

13. The system of claim 12, wherein said terminal comprises a printer, said first module configured to issue a transaction receipt by sending print information to said printer, wherein said second module is configured to obtain the transaction related information from said print information.

14. The system of claim 13, wherein said tag or indicator is added by said second module to said print information and is printed with said transaction receipt.

15. The system of claim 1, wherein cash handling device is configured to mark as processed the transaction related information associated with said input tag or indicator after the cash amount is dispensed.

16. The system of claim 1, wherein if transaction related information for more than one transaction is associated with the same tag or identifier, then a secondary identifier is also used to uniquely identify each transaction in said database.

17. A system for cash handling applicable to an industry, comprising:
a database configured to store transaction related information;
a cash or financial instrument acceptance device having a first module configured to receive cash or a financial instrument and generate transaction related information based on the received cash or financial instrument, and a second module configured to receive or obtain the transaction related information generated by said first module, assign a tag or indicator to the transaction related information, and save the transaction related information in association with the assigned tag or indicator in said database, wherein the transaction related information includes a deposited amount; and
a teller terminal having an input device configured to receive an input tag or indicator, said terminal configured to look up the input tag or indicator in said database and determine the transaction related information associated with the input tag or indicator, and complete a transaction for the transaction related information.

18. The system of claim 17, wherein said second module directly receives the transaction related information from said first module.

19. The system of claim 17, wherein said cash or financial instrument acceptance device includes a display screen and said second module obtains the transaction data through extraction from the display screen.

20. The system of claim 17, wherein said tag or indicator is a number.

21. The system of claim 20, wherein said tag or indicator is a bar coded representation of the number, and said terminal comprises a bar code reader configured to read the input tag or indicator.

22. The system of claim 17, wherein said tag or indicator includes information on a magnetic card, said terminal having a card reader for reading the input tag or indicator.

23. The system of claim 17, wherein said tag or indicator includes information on an RFID component, said terminal having an RFID reader device for reading the input tag or indicator.

24. The system of claim 17, wherein said tag or indicator includes biometric information, each of said terminal and said cash or financial instrument acceptance device includes a biometric device.

25. The system of claim 17, wherein said terminal is configured to mark as processed the transaction related information associated with said input tag or indicator after the transaction is processed.

26. The system of claim 17, wherein if transaction related information for more than one transaction is associated with the same tag or identifier, then a secondary identifier is also used to uniquely identify each transaction in said database.

27. A method of cash handling, comprising:
initiating a transaction at a terminal;
determining transaction related information associated with the transaction using a first module in the terminal;
activating a program in a second module for assigning a tag or indicator to the transaction related information;
saving the transaction related information in association with the assigned tag or indicator in a database, wherein the transaction related information includes a cash amount;
inputting, by the customer, the tag or indicator to a cash handling device arranged remote from the terminal;
querying, by the cash handling device, the database for the tag or indicator; and
if the tag or indicator is found in the database, determining the transaction related information associated with the tag or indicator, and dispensing the cash amount associated with the transaction related information.

28. The method of claim 27, further comprising the step:
if the tag or indicator is not found in the database, repeating the steps of inputting and querying.

29. The method of claim 28, initiating supervisory intervention if the tag or indicator is not found after a predetermined number of attempts.

30. The method of claim 27, wherein the tag or indicator is a number generated by the second module.

31. The method of claim 30, wherein the tag or indicator is a bar coded representation of the number provided to the customer, and the cash handling device includes a barcode reader, said step of inputting comprises reading, by the bar code reader, the bar coded representation.

32. The method of claim 27, wherein the tag or indicator includes information on a magnetic card, said step of activating comprising sliding the magnetic card through a card reader at the terminal for obtaining the input tag or indicator, and said step of inputting comprising sliding the magnetic card through a card reader at the cash handling device.

33. The method of claim 27, wherein the tag or indicator includes information on an RFID component and the cash handling device has an RFID reader device, said step of inputting comprising reading, by the RFID reader device, the input tag or indicator.

34. The method of claim 27, wherein said tag or indicator includes biometric information, each of said terminal and said cash handling machine including a biometric device, said step of assigning comprising determining biometric information for a customer using a biometric device at the terminal and said step of inputting comprising reading the input tag or indicator using the biometric device at the cash handling device.

35. A method of cash handling, comprising the steps of:
initiating a transaction at a cash or financial instrument acceptance device;
receiving cash or a financial instrument at a cash or financial instrument acceptance device;
generating, by a first module in the cash or financial instrument acceptance device, transaction related information based on the received cash or financial instrument;
receiving or obtaining, by a second module in the cash or financial instrument acceptance device, the transaction related information generated by said first module;
assigning, by the second module in the cash or financial instrument acceptance device, a tag or indicator to the transaction related information;
saving, by the second module in the cash or financial instrument acceptance device, the transaction related information in association with the assigned tag or indicator in said database, wherein the transaction related information includes a deposit amount;
inputting, by a customer, to a teller terminal the tag or indicator, the teller terminal being remote from the cash or financial instrument acceptance device;
querying, by the terminal, the database for the input tag or indicator; and
if the input tag or indicator is found, then determining the transaction related information associated with the input tag or indicator, and completing a transaction for the transaction related information.

36. The method of claim 35, further comprising the step:
if the tag or indicator is not found in the database, repeating the steps of inputting and querying.

37. The method of claim 36, initiating supervisory intervention if the tag or indicator is not found after a predetermined number of attempts.

38. The method of claim 35, wherein the tag or indicator is a number generated by the second module.

39. The method of claim 38, wherein the tag or indicator is a bar coded representation of the number provided to the customer, and the terminal includes a barcode reader, said step of inputting comprises reading, by the bar code reader, the bar coded representation.

40. The method of claim 35, wherein said tag or indicator includes information on a magnetic card, said step of activating comprising sliding the magnetic card through a card reader at said cash or financial instrument acceptance device for obtaining the tag or indicator, the terminal having a card reader for reading the input tag or indicator, wherein said step of inputting comprises sliding the magnetic card through the card reader at the terminal.

41. The method of claim 35, wherein the tag or indicator includes information on an RFID component and the terminal has an RFID reader device, said step of inputting comprising reading, by the RFID reader device, the input tag or indicator.

42. The method of claim 35, wherein the tag or indicator includes biometric information, each of the terminal and the cash or financial instrument acceptance device including a biometric device, said step of assigning comprising determining biometric information for a customer using a biometric device at the cash or financial instrument acceptance device and said step of inputting comprising reading the input tag or indicator using the biometric device at the terminal.

43. A program module in a computer system comprising a terminal running a cash handling program, a database, and a cash handling device, the cash handling program generating a transaction having transaction related information including a cash amount to be dispensed, said program module comprising computer executable instructions for:
determining transaction related information associated with the transaction;
assigning a tag or indicator to the transaction related information; and
saving the transaction related information in association with the assigned tag or indicator in a database, the database being accessible by the cash handling device for dispensing the cash amount.

44. A program module in a computer system comprising a terminal running a teller program, a database, and a cash handling device running a deposit program for receiving cash or financial instruments, the deposit program generating a transaction having transaction related information including a deposited cash amount, said program module comprising computer executable instructions for:
determining the transaction related information associated with the transaction;
assigning a tag or indicator to the transaction related information; and
saving the transaction related information in association with the assigned tag or indicator in a database, the database being accessible by the terminal to complete the transaction.
